(19) United States
(12) Patent Application Publication
(10) Pub. No.: US 2010/0252296 A1
(43) Pub. Date: Oct. 7, 2010

(54) TEMPORARY PROTECTIVE COVER/GUIDE FOR ELECTRICAL/COMMUNICATIONS BOXES

(76) Inventor: Richard S. Wiggins, Edmonds, WA (US)

Correspondence Address: Oliver Law Firm, PS Inc., 1113 Hoyle Ln, Waxhaw, NC, 28173, US

(21) Appl. No.: 12/743,258

(22) PCT Filed: Jan. 14, 2009
(86) PCT No.: PCT/US09/30951

§ 371 Date: May 17, 2010

Related U.S. Application Data
(60) Provisional application No. 61/020,817, filed on Jan. 14, 2008.

(51) Int. Cl. H02G 3/14; E04G 23/00

(52) U.S. Cl. 174/66; 52/745.2

(57) ABSTRACT

A cover/guide for an electrical/communications box is typically vacuum-formed from a transparent polymeric material and needs no tools for installation or removal. The temporary cover is designed to interference fit within a universal electrical/communications box and can be used to protect wiring and other devices from dust, paint, stucco, etc during construction. The cover/guide also provides an easy method for location under hung drywall. If not made from a transparent material, the cover/guide may define a transparent viewing area for inspection and/or identification of the box's interior components.

### RELATED APPLICATIONS

This application is related to and claims priority under 35 U.S.C. 119(e) to U.S. provisional application Ser. No. 61/020,817, entitled “Electrical/Communications Box Cover/Guide,” filed on Jan. 14, 2008, with inventor Richard S. Wiggins, which is hereby incorporated by reference in its entirety.

### FIELD OF THE INVENTION

This invention pertains generally to protective coverings for openings and more particularly to temporary protective covers for electrical/communications boxes.

### BACKGROUND OF THE FIELD

Installing drywall, stucco, other types of wall facings may typically introduce dust, paint, texture, or other undesirable elements into electrical/communications boxes unless those boxes are covered during the construction. Likewise repair and paint can introduce similar unwanted elements into the boxes. However, covering the boxes with a metal covering prevents inspection and identification of the boxes interiors. Metal also can conduct electricity and therefore presents a safety risk to workers and others. Various patents have tried to address some of these issues but fail to recognize all of the problems facing the industry today and so do not offer comprehensive solutions.

U.S. Pat. No. 6,867,369 to Wiggins discloses a plastic, temporary box cover that can be useful in such situations. However Wiggins' box cover has a recessed base which not only renders the box hard to find under an installed drywall sheet but also limits the type of box (i.e., components) it may be used on because the box's components cannot protrude past the recessed base.

Oliver et al. in U.S. Pat. No. 6,166,329 disclose a cover for protecting electrical device assemblies during installation. However, Oliver's rigid cover requires tools for installation and removal, is made of metal, which can conduct electricity—thereby risking injury to workers—and is intended only for protecting the box's components from a drill or other cutting device.

Green in U.S. Pat. No. 5,526,952 discloses a protective cover for electrical boxes. However Green's rigid cover is unnecessarily complicated and is attached to the electrical box with screws, making it difficult and time-consuming to install and remove.

Jordan in U.S. Pat. No. 5,562,222 discloses a temporary cover for electrical outlet boxes. However, Jordan's device is flush with the surrounding box edge, making it difficult to find after the drywall or other wall facing has been applied.

Compagnone, Jr. in U.S. Pat. No. 6,686,540 discloses a temporary protective cover for an electrical box. Campagnone's flush cover has depending rails which provide an interference fit with the box's perimeter walls. However, Campagnone's device does not have any kind of a viewing area, and also cannot accommodate pre-wired devices. Further, Compagnone's device defines only a small recessed handle for pinching. Along with other devices that offer a protruding handle for pinching, this pinch is a difficult precision manipulation and requires extra time from the installer/remover.

Compagnone, Jr. in U.S. Pat. No. 7,442,874 also discloses a temporary protective cover for an electrical box. Compagnone's device, like many of the other prior art covers, uses interior pins or posts to secure the cover from sliding laterally or longitudinally, making the cover more complicated to manufacture, and requiring more precision in installation.

Brennan in U.S. Patent Application No. 2007/0023427 discloses a temporary protective cover for electrical outlet boxes. Brennan's device, however, needs tools for installation/removal, does not allow for a transparent viewing area, and may be hard to find under drywall or other wall facing material.

### SUMMARY OF THE INVENTION

The present invention is directed to a temporary protective cover that is inexpensive to manufacture, easy to use, protects people from electric shock, and keeps messy construction mud and paint away from sensitive electrical conductors, The cover of the present invention is designed to friction fit within a universal electrical/communications box and may define a transparent unobstructed viewing area for inspection and/or identification of the box's interior components.

Each electrical/communications box has a perimeter side wall with a substantially planar upper edge that defines an opening within the box. Various electrical and/or communication wires or cables—or other components—may be pulled inside the box. The temporary cover may have a substantially planar pop-out base, which extends beyond the upper edge of the box, to accommodate various components within the box including switch plates and outlet plates. As suppliers are increasingly providing electrical and communications components already assembled in the boxes, it is necessary for the temporary protective cover to accommodate these changing configurations.

The temporary cover may also have a perimeter side wall such that the side wall is affixed generally orthogonally to the base, and which includes a lower edge to which a perimeter flange may be attached. The perimeter flange will typically mate with the perimeter edge of the box and may extend generally orthogonally from the perimeter side wall all the way around the cover and box—in all four directions—to give maximum coverage, or may be designed to extend in segments around certain parts of the cover—perhaps for use in space-limited locations. The flange typically aids in preventing dust and other unwanted particles from entering the box and depositing on the components therein, especially if the cover shifts slightly either longitudinally or laterally relative to the box edge during vibration of the construction frame, friction forces from drywall being hanged, rain, wind, or any other stimulus.

On the side of the flange opposite the pop-out base, there will be two or more depending side rails designed (sized and shaped) to provide an interference fit with at least a portion of the perimeter side wall of the box itself. In one aspect of the invention, these rails are provided as two side rails—typically along the long sides of a generally rectangular cover to fit a common rectangular universal electrical/communications box—but may alternatively be provided on the ends of the rectangle. There even could be rails on all four sides to offer increased security of the cover to the box. In alternate embodiments, in which the cover's general shape is a circle, a square, or some other regular or irregular shape, the depending rails may be designed as desired. The rails may be extended the length of the corresponding box opening in order to help prevent longitudinal and lateral shifting of the cover during vibration of the construction frame, friction forces from drywall being hanged, rain, wind or any other stimulus.

The temporary cover of the present invention is intended to be made from molded plastic or other polymeric material. Plastic is a safer alternative to metal in that it is non-conductive as to any energized wires. It is also lighter in weight and because it uses no screws, nails, or other tools, is also faster to install and remove. The user simply squeezes the opposite sides of the pop-out base to relieve the interference fit and thereby install or remove the cover. To provide for this method of installation/removal, it is necessary that the plastic be a certain thickness. If the plastic is too thick, then flexibility and hence, versatility, may be lost.

The cover/guide of the present invention is typically made from a thermal, vacuum-forming process. Injection-molded covers or other covers made of metal cannot achieve the clear viewing that is anticipated by this invention. Such clarity, or transparency, is important so that the superintendents on the job or other inspectors can easily inspect the box's interior components to ensure that the proper device is properly installed (e.g., switch, receptacle, GFI outlet, etc,). Devices are getting more specific in nature and also in specifications required; so, such inspection is increasingly more precise. As safety becomes a stronger issue, and codes and laws change to a safer industry, devices have added on more safety features, and the use of them is becoming increasingly more prevalent. Vacuum forming offers advantages over other methods of manufacturing in this regard.

The pop-out base of the cover, particularly as opposed to a recessed or flush base, provides for a natural marker during drywall construction. When a sheet of drywall, or other wall facing material, is applied over the covered electrical box, there will be a bump—or tent—over the pop-out cover indicating the location of the electrical box. The drywall installer can then mark the location of the box, drill at the mark so that the cover is visible, and then proceed to drill or cut out the remaining drywall over the box and cover. Once the dwell falls back to its flat state surrounding the box cover (substantially flush with the cover's flange), the components of the box can be identified and/or inspected through the transparent viewing area of the cover, or the cover an removed for further work in the interior of the box.

The plastic of the cover's base must be thick enough to provide enough strength to the cover to withstand slight pressure by the drywall drill or other tool used to cut through the wall facing material. At the same time, the cover acts to protect the components inside the box.

### BRIEF DESCRIPTION OF THE DRAWINGS

The objects, features, and advantages of the present invention will be apparent to one skilled in the art from reading the following description in which:

FIG. 1 is a perspective view of the preferred embodiment of the protective cover/guide prior to being interference fit within an opening defined by the side walls of an electrical/communications box;

FIG. 2 is a right side view of the cover/guide;

FIG. 3 is a sectional view of the cover/guide taken substantially along lines 3-3 of FIG. 1;

FIG. 4 is a sectional view of the cover/guide taken substantially along lines 4-4 of FIG. 1;

FIG. 5 is a rear view of the cover/guide;

FIG. 6 is a sectional view of a cover/guide, similar to FIG. 4, illustrating the interference fit within an electrical box, with the upper edges of the box shown in broken lines;

FIG. 7 is a front view of a sheet of drywall tented over a stud and electrical box including the cover/guide, with a portion of the stud and cover/guide and electrical box shown in cutaway;

FIG. 8 is a perspective view of a rotor or drywall drill about to make a hole in the drywall sheet where the cover/guide and electrical box are located;

FIG. 9 is a side view of a drill bit breaking through the drywall sheet;

FIG. 10 is a front view of the electrical box and connectors as seen through a transparent cover/guide of the present invention through the hole formed in the drywall sheet;

FIG. 11 is a sectional view of electrical box and cover/guide and drywall taken substantially across lines 11-11 of FIG. 10 shown after the drywall sheet has moved back into its predestined, flat state once the hole formed in the drywall sheet fits over the cover/guide (the interior components have been removed for clarity);

FIG. 12 is a front view of an alternate embodiment of a pre-assembled electrical box with an outlet device already installed; and

FIG. 13 is a front view of an alternate embodiment of a double gang version of the cover/guide.

### DETAILED DESCRIPTION

The following specification describes a temporary protective cover/drywall guide for electrical/communications boxes apparatus and method. In the description, specific materials and configurations are set forth in order to provide a more complete understanding of the present invention. But it is understood by those skilled in the art that the present it can be practiced without those specific details. In some instances, well-known elements are not described precisely so as not to obscure the invention.

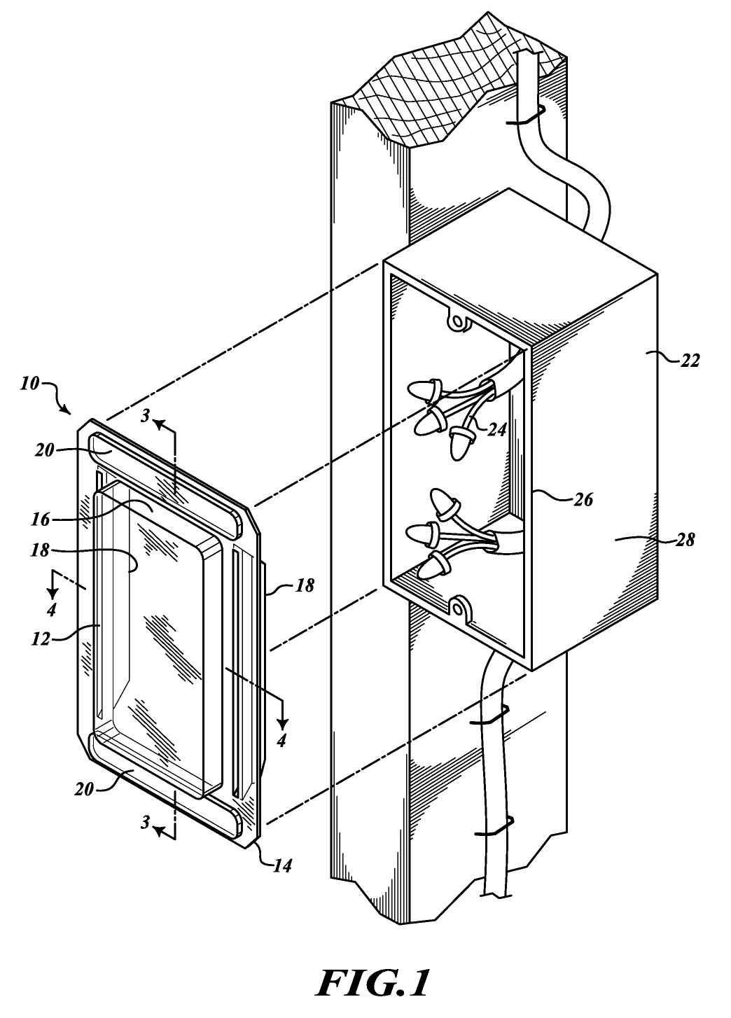

FIG. 1 is a perspective view of a preferred embodiment of the cover/guide prior to being interference fit within an opening defined by the perimeter side wall 28 and upper perimeter edge 26 of an electrical/communications box. The cover/guide 10 may comprise an pop-out base 12 surrounded by and generally coplanar with a perimeter flange 14, between which is disposed a perimeter wall 16 (oriented generally orthogonally to the base and the flange). In this illustration, the cover/guide 10 is shown as rectangular in shape to accommodate a single gang box because that is the shape of most conventional electrical, communications, and plumbing boxes used in building construction. However, it is understood that the cover/guide could be circular, square, or of any other regular or irregular shape to accommodate the box to be covered, including double-, and triple-gang configurations.

Two depending side rails 18 are disposed along the long sides of the rectangular cover/guide, opposite the perimeter wall 16 and across the flange 14. Any number of depending side rails, as long as they are disposed opposite one another across the base to achieve the interference fit necessary, would be workable, and they may be located at any desired location around the cover/guide in order to accommodate the box to be covered (for instance to avoid fastener heads or wire conduits). The site rails 18 are designed to angle or hook outward (i.e., away from the base 12) so as to provide an interference fit with the sidewalls of the electrical/communications box 22. The outward urging of these hooks portions provides the interference fit.

In addition to providing the interference fit, the side rails 18 have the function of limiting any longitudinal or lateral shifting of the cover relative to the box edge. Such function is necessary because during construction, the construction frame, including the box's adjacent stud, may be vibrated with the use of various tools, or the cover of the box may be tapped or sheared with drywall while it is being hung. In certain situations, the cover may even be impacted by wind, rain, or other environmental conditions that may cause sliding of the cover relative to the box edge. If not prevented or checked, such sliding or shifting may impinge upon the interior components or even open a gap between the cover and the box edge, so that the interior components are no longer protected from dust, etc.

In addition to the side rails 18, the flange 14 helps to protect the box's interior components in case of a sliding or shifting cover. The flange precludes that any gap will open between the cover and the box edge. The flange 14 will be wide enough (i.e., extend away from the perimeter wall far enough) to preclude any such gap. Also, the flange 14 may define one or more bumpouts 20 to accommodate fastener heads.

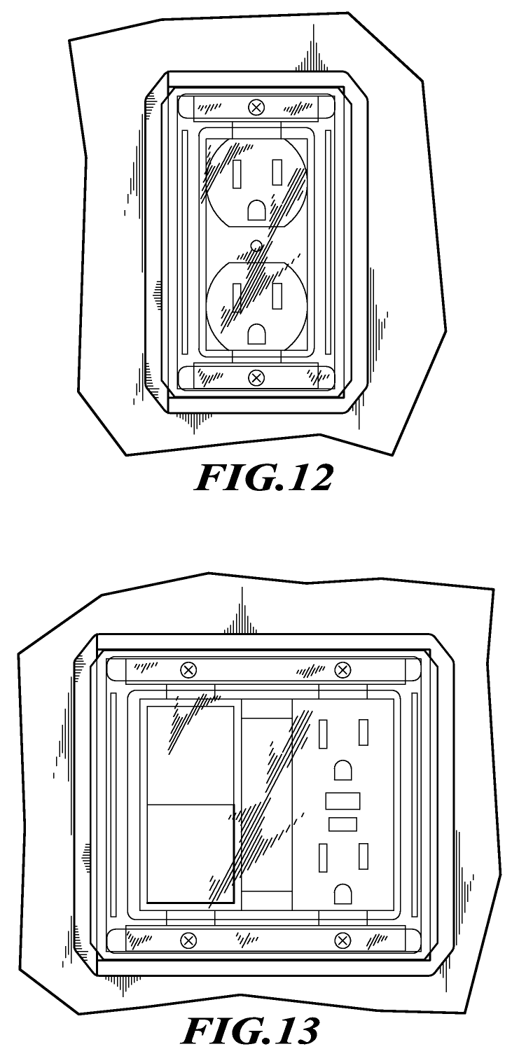

Once the electrical conductors 24 or other interior components are pulled to the box 22, the box can be covered with the cover/guide of the invention to maintain the integrity of the box and keep out dust, paint, mud, and other undesirable debris. The installer simply pops the cover/guide onto or off of the box edge by slightly squeezing the sides of the cover/guide 10 (easier than pinching a small central handle). Today, many electrical boxes are being provided to the installer with outlet devices, switch devices, or other components already attached (see FIG. 12). In these cases, the interior components of the box may extend beyond the perimeter edge 26. The pop-out base 12 of the present cover/guide allows room for these and like devices.

The cover/guide of the present invention is typically made from a polymeric material, such as plastic, using a thermal, vacuum-forming process. Injection-molded covers or other covers made of metal cannot achieve the clear viewing that is anticipated by this invention. Such clarity, or transparency, is important so that the superintendents on the job or other inspectors can easily inspect the box's interior components to ensure that the proper device is properly installed (e.g., switch, receptacle, GFI outlet, etc.). Devices are getting more specific in nature and also in specifications required; so, such inspection is increasingly more necessary and precise. As safety becomes a stronger issue, and codes and laws change to a safer industry, devices have added on more safety features, and the use of them is becoming increasingly more prevalent. Vacuum forming offers advantages over other methods of manufacturing in this regard.

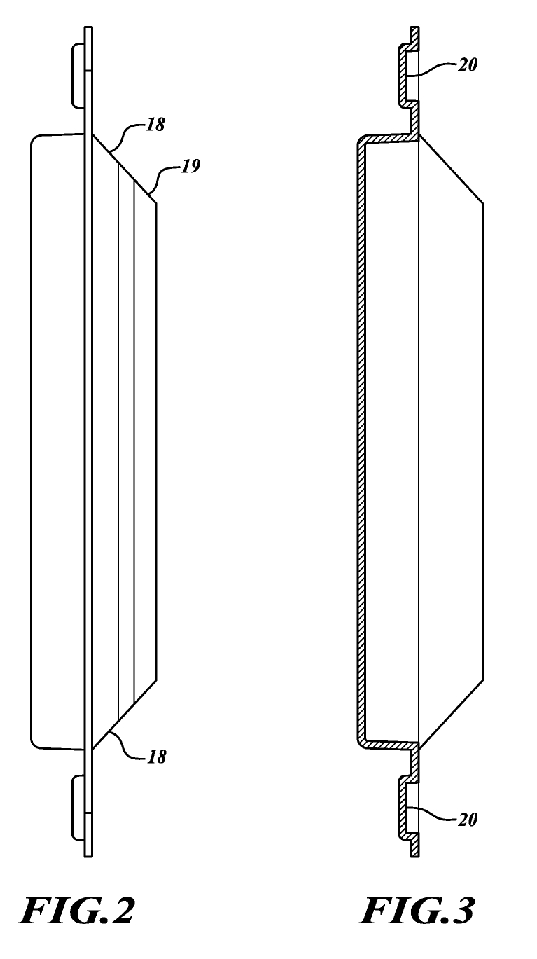

FIG. 2 is a right side view of the cover/guide 10 and shows how the side rails 18 may be angled/tapered at their ends to facilitate installation and removal. FIG. 3 is a right side sectional view of the cover/guide taken substantially along lines 3-3 of FIG. 1 and shows the bumpouts 20 which are designed to accommodate any fastener heads, such as the screws typically located around the edges of electrical/communications boxes.

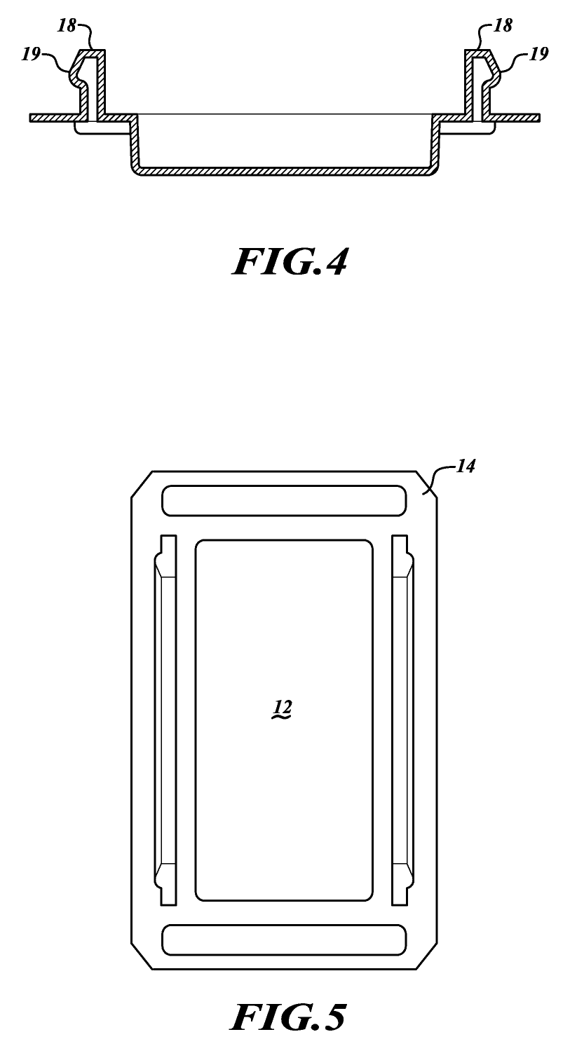

FIG. 4 is a sectional view of the cover/guide taken substantially along lines 4-4 of FIG. 1 (end view), showing how the side rails 18 are disposed at rest, i.e., before being squeezed or installed into a box. It has been mentioned earlier in this specification how—regardless of number or design—the side rails 18 are meant to oppose one another and can be angled or hooked outwardly, so as to provide the interference fit with the perimeter sidewall 28 of the electrical/communication box. In this embodiment, the side rails 18 comprise hook portions 19 to provide that interference fit. FIG. 5 is a rear view of the cover/guide, showing how the flange 14 in this embodiment surrounds the cover/guide completely and extends orthogonally in all directions, coplanar with the base 12. The flange 14 covers the entire perimeter edge 26 of the box (and beyond) and helps to keep dust, paint, mud, etc., away from the interior of the box.

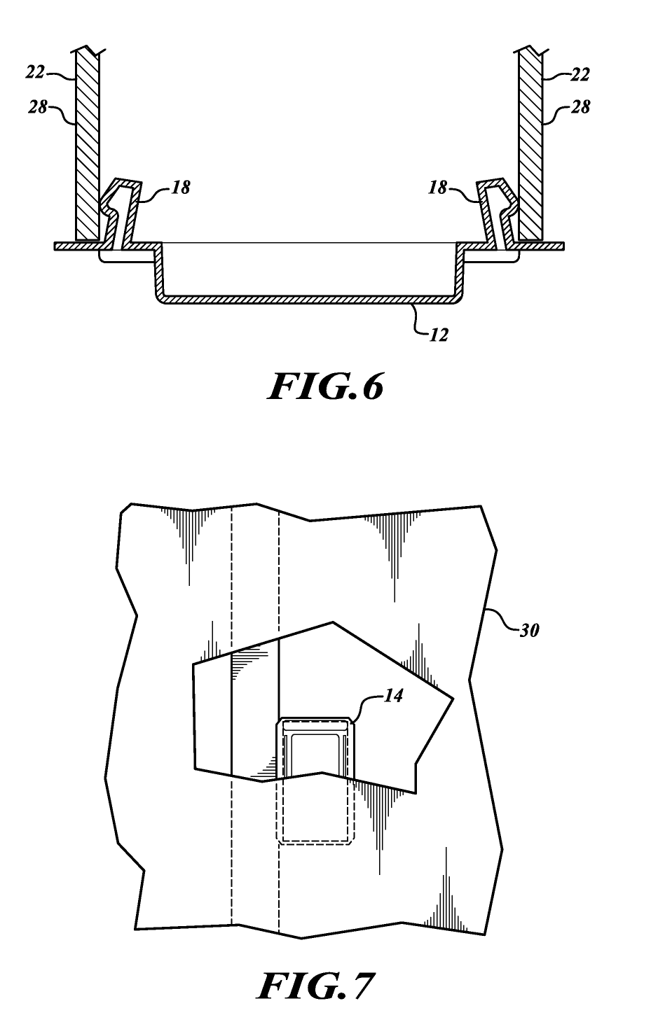

FIG. 6 is the same sectional view of a cover/guide, showing how the side rails 18 may be deformed by the interference fit within an electrical box 22. This illustration also shows how the pop-out base 12 extends (e.g., is spaced outwardly) from the upper edge of the box 22. The extended, pop-out base 12 may allow an air gap to exist between the pop-out base 12 of the cover/guide and the interior components of the box 22, further protecting them from unintended consequences. Alternatively, the electrical or other device (such as that shown in FIG. 12) may be in contact with the base and may therefore help to limit any shifting of the cover.

Once the cover/guide 10 has been installed and covers the box 22, a sheet of drywall 30 or other wall facing material may be applied. The protective cover can now also act as a drywall guide. Because the pop-out base 12 of the cover/guide extends beyond the opening of the box, the drywall will not hang flush, but will be slightly tented over the cover/guide. FIG. 7 is a front view of a sheet of drywall tented over a stud and electrical box and includes the cover/guide with a portion of the stud. Portions of the cover/guide and electrical box are also shown in cutaway. It can be seen how the flange 14 extends beyond the edge of the box, offering more protection to the interior of the box than just the pop-out base 12 alone.

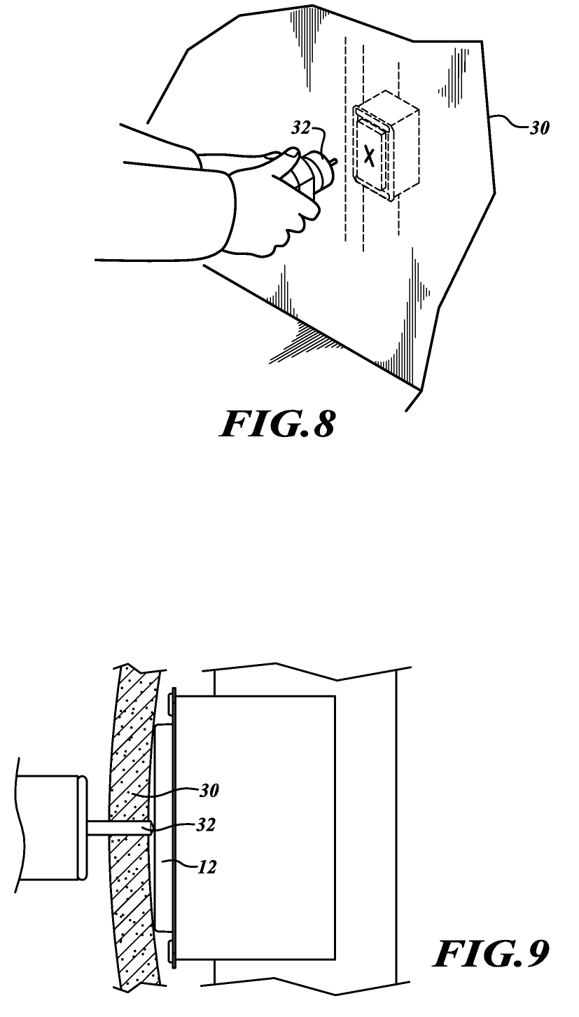

FIG. 8 is a perspective view of a rotor or drywall drill 32 about to make a hole in the drywall sheet 30 where the cover/guide and electrical box are located. Prior to drilling, the worker may make a mark/spot at the location where he supposes the cover/guide to be. The tent, or bump, over the cover/guide may help in this step by indicating at its apex where the cover/guide is located. Once the location has been determined and marked where the box is thought to be under the drywall sheet (e.g., at the apex of the tent), the worker directs the drill 32 toward the cover/guide, makes a hole with the drilling device, and removes the intervening portion of the drywall sheet 30. FIG. 9 is a side view of a drill bit 32 breaking through the drywall sheet 30. The drill bit 32 typically breaks through at a location adjacent the pop-out base 12 of the cover/guide and then moves toward the edges of the cover/guide to remove the drywall sheet between the box and the cover/guide. The cover/guide 10, or at least the base 12, may be manufactured from a polymeric (e.g., plastic) material that is flexible enough to pop on and off, but is stiff enough to withstand the slight pressure by the drill bit. The inventor has found that a thickness less than 25 mils may not be enough to withstand the pressure, but that above a thickness of approximately 50 mils, the cover/base is too stiff to allow easy installation and removal. Therefore, a thickness of 25-50 mils may be optimum to provide the necessary resistance to a drill bit or other cutting device. The entire cover/guide may be made (for facility of manufacture) from this material at this thickness.

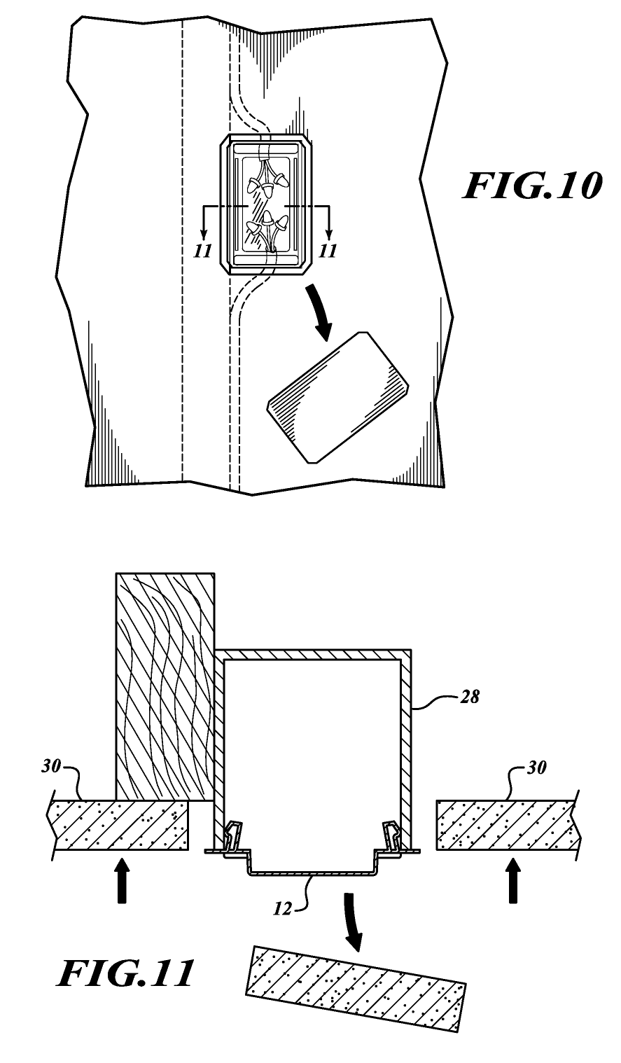

FIG. 10 is a front view of the electrical box and connectors as seen through a transparent cover/guide 10 of the present invention through the hole formed in the drywall sheet 30. The material of the cover/guide 10 may be made from any appropriate material, but may in various embodiments, be transparent or have a transparent unobstructed viewing area in the pop-out base 12. Such transparency (i.e. clarity) allows an inspector to view the interior components without compromising their protected state. In this illustration, a transparent cover/guide is used; however, even if the cover/guide were relatively opaque (perhaps with a transparent viewing area), then the inspector would still be able to confirm that the electrical/communications box was unmolested in its proper location under the drywall sheet.

FIG. 11 is a sectional view of an electrical box and cover/guide 10 and the surrounding drywall taken substantially across lines 11-11 of FIG. 10 shown after the drywall sheet has moved back into its predestined, flat state once the hole formed in the drywall sheet 30 fits over the cover/guide. The worker should endure that the drywall is flat around the electrical/communications box. The cover/guide still maintains its interference fit with the perimeter side wall 28 of the box so that the interior components are still protected. At this point, the cover/guide may be removed by squeezing the sides of the pop-out base 12 to relieve the interference fit. No tools are needed.

FIG. 12 is a front view of an alternate embodiment of a pre-assembled electrical box with an outlet device already installed. The pop-out base 12 easily accommodates the interior components including the outlet device, switch device, or other device, and its transparency allows straightforward identification and inspection of the interior components. The bumpouts also easily accommodate the screw heads at either end of the box.

FIG. 13 is a front view of an alternate embodiment of a double gang version of the cover/guide, also with a transparent viewing area on the base. Although the cover/guide in the preferred embodiment is a single gang version, because single gang electrical boxes are most common, the invention can easily be designed in different shapes and sizes.

What is claimed is:

1. A protective cover/drywall guide for a universal electrical/communications box, wherein said box includes a perimeter side wall having a substantially planar upper edge, said cover/guide comprising: a substantially planar base and a perimeter side wall affixed to and extending substantially orthogonally from the planar base; said perimeter side wall of the cover/guide having a lower edge from which an outwardly extending flange is affixed; a plurality of side rails extending oppositely from the base across the flange and sized and shaped so that they may interference it within at least a portion of the perimeter side wall of the electrical/communications box; wherein in use, the planar base is extended from the upper edge of the box, and the flange of the cover/guide fits over at least a portion of the upper edge of the box side wall; wherein said cover/guide is capable of being readily attached to and removed from the box.

2. The protective cover/drywall guide of claim 1 wherein said planar base is extended from the opening of the electrical/communications box to provide an air gap between said planar base and any interior components of said electrical/communications box.

3. The protective cover/drywall guide of claim 1 wherein said depending side rails are arranged oppositely of one another across said planar base.

4. The protective cover/drywall guide of claim 1 wherein said interference fit is caused by outwardly urging portions of said side rails.

5. The protective cover/drywall guide of claim 1 further including a transparent unobstructed viewing area that at least covers a portion of the planar base.

6. The protective cover/drywall guide of claim 1 wherein said outwardly extending flange defines at least one bumpout to accommodate fastener heads.

7. The protective cover/drywall guide of claim 1 in which the entire guide is made from vacuum-formed polymeric material being generally thick enough to provide the stiffness to resist a cutting tool.

8. The protective cover/drywall guide of claim 1 in which the entire guide is made from molded plastic having a general thickness between 25 and 50 mils.

9. A protective cover/drywall guide for a universal electrical/communications box, wherein said box includes a perimeter side wall having a substantially planar upper edge, said cover/guide comprising: a substantially planar pop-out base and a perimeter side wall affixed to and extending substantially orthogonally from the planar pop-out base; said perimeter side wall of the cover/guide having a lower edge from which an outwardly extending perimeter flange is affixed; a plurality of side rails extending oppositely from the pop-out base across the flange and sized and shaped so that they may interference fit within at least a portion of the perimeter side wall of the electrical/communications box; wherein in use, the planar pop-out base is spaced outwardly from upper edge of the box, and the flange of the cover/guide fits over the perimeter edge of the box side wall; wherein said cover/guide is capable of being readily attached to and removed from the box.

10. The protective cover/drywall guide of claim 9 wherein said cover/guide is attached and removed from the box opening by squeezing opposing sides of said pop-out base.

11. The protective cover/guide of claim 10 wherein said side rally prevent shifting of said cover/guide relative to said perimeter edge of said electrical/communications box.

12. The protective cover/guide of claim 11 wherein said cover/guide is configured to accommodate a single-gang electrical box.

13. The protective cover/guide of claim 11 wherein said interior components include an electrical device.

14. A method of installing a sheet of drywall over an electrical/communications box, the method comprising: applying a universal electrical/communications box to an adjacent stud; pulling interior components to the box; installing a protective cover/guide of a size and shape to interference fit within the box over the interior components and such that the cover/guide includes a perimeter side wall and a pop-out base, said pop-out base including a perimeter flange extending outwardly of the perimeter side wall, and that the cover/guide is extended from the box; applying a drywall sheet over the stud and the covered box such that the sheet is tented over the box; marking a spot where the box is thought to be under the drywall sheet; making a hole with a drilling device where the marked spot is through the drywall sheet and into contact with the pop-out base of the cover/guide; and moving the drilling device toward the edges of the cover/guide to remove drywall between the box and the cover.

15. The method of claim 14 wherein said pop-out base further includes a transparent and unobstructed viewing area.

16. The method of claim 14 wherein said interference fit is provided by outwardly urging depending side walls from said perimeter flange.

17. The method of claim 14 wherein existing fastener heads on said adjacent stud are accommodated by bumpouts defined on said perimeter flange.

18. The method of claim 14 wherein said spot is marked generally at the apex of the drywall tent formed over the cover/guide.

19. The method of claim 14 further including the step of ensuring that the drywall sheet falls back into its flat state around the electrical/communications box.
